(19) United States
(12) Patent Application Publication
(10) Pub. No.: US 2010/0201593 A1
(43) Pub. Date: Aug. 12, 2010

(54) ANTENNA ARRANGEMENT FOR A MULTI RADIATOR BASE STATION ANTENNA

(75) Inventors: Stefan Jonsson, Stocksund (SE); Dan Karlsson, Solna (SE)

Correspondence Address: THE JANSSON FIRM, 3616 Far West Blvd, Ste 117-314, AUSTIN, TX, 78731, US

(73) Assignee: Cellmax Technologies AB, Taby (SE)

(21) Appl. No.: 12/679,533

(22) PCT Filed: Sep. 19, 2008
(86) PCT No.: PCT/SE2008/051053

§ 371 Date: Mar. 23, 2010

(30) Foreign Application Priority Data
Sep. 24, 2007 (SE) 0702123-1

(51) Int. Cl. H01Q 21/08; H01P 1/18

(52) U.S. Cl. 343/824

(57) ABSTRACT

Antenna arrangement for a multi radiator base station antenna, the antenna having a feeding network based on air filled coaxial lines (15; 19), wherein the coaxial line being an integrated part of a back side of an antenna reflector (1), and wherein the coaxial line comprises an outer conductor (9) and an inner conductor (7; 14). Two parallel columns of radiators (11) are placed on a front side of the antenna reflector (1), the radiators (11) being fed from said feeding network.

The present invention relates to an antenna arrangement for a multi radiator base station antenna, the antenna having a feeding network based on air filled coaxial lines, wherein the coaxial lines are an integrated part of the antenna reflector. The invention especially relates to such a dual polarised antenna having two parallel columns with dual polarised radiators.

Antennas in telecommunication systems such as cellular networks today typically use multi-radiator structures. Such antennas make use of an internal feeding network that distributes the signal to the radiators from a common coaxial connector when the antenna is transmitting and in the opposite direction when the antenna is receiving. Typically radiators are positioned in a vertical column and radiators are fed via a feeding network from a common connector in a single polarisation antenna case, or fed via two feeding networks from two connectors in a dual polarisation case. This vertical column arrangement reduces the elevation beam width of the antenna and increases the antenna gain.

For a single-column antenna, the azimuth beam width is determined by the shape of the reflector and the radiator. Approximately, antenna gain is inversely proportional to the antenna beam width. In order to make a narrow azimuth beam width antenna two or more columns of radiators are typically used. Typical applications are road or railroad sites, or sites that use six sectors instead of the commonly used three sectors. For road and railroad sites, higher antenna gain allows the operator to use a larger distance between sites. A six-sector site can be used to increase the capacity of a cellular network without increasing the number of sites, or to increase the area coverage of a given site by using antennas with higher gain achieved by the narrower azimuth beam width.

Today, cellular antennas often have radiators that can radiate in two orthogonal polarisations. Each polarisation is associated to a feeding network. Thus, two orthogonal channels are created that can be connected to a diversity receiver in the base station. Using diversity reduces fading dips and thus enhances the sensitivity of the receiver. In order for the diversity to be efficient, the signals from the two channels must be sufficiently uncorrelated. Therefore it is necessary to maintain certain isolation between the two channels. For diversity purposes 20 dB isolation is enough, but customers usually specify 30 dB due to filter specification issues in the base station.

For a two-column antenna, the azimuth antenna pattern primarily depends on a complex interaction between the width and shape of the reflector, the radiation pattern of the radiators and the separation between the radiators. It is often difficult to combine high gain with low azimuth side lobe level. Low azimuth side lobe level is important in order to reduce interference from neighbouring sectors.

The object of the present invention is therefore to provide a novel narrow azimuth beam dual polarised antenna having higher gain than presently available antennas together with low azimuth side lobe level and sufficient isolation between channels.

This object is obtained with an antenna, wherein two parallel columns of radiators are placed on the reflector front side, and the radiators are fed from a feeding network on the back side of the reflector.

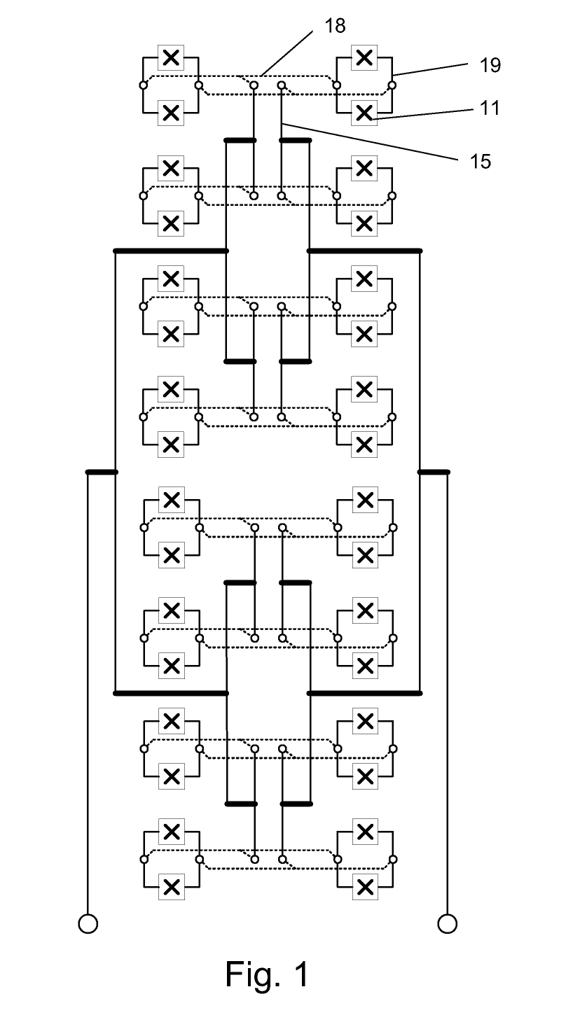

The present invention relates to a two-column antenna that uses a low loss feeding network similar to that described in applicant's earlier application WO 2005/101566 A1. In FIG. 1 is shown an embodiment of a two-column antenna with 32 radiators. To reduce the number of parts, it is beneficial to reuse the same feeding network for both antenna columns as much as possible. In this embodiment, only the coaxial lines that link two radiators in pairs are duplicated, all other coaxial lines are common for both antenna columns.

The antenna feeding network uses a number of splitters/combiners (reciprocal networks) that split/combine the signal in two or more. In order to simplify the text, only the splitting (transmitting) function is described. The splitter/combiner is fully reciprocal which means that the same type of reasoning can be applied also to the combining (receiving) function.

It can be seen from FIG. 1 that it is necessary for signal paths to cross each other. Conventional two-column antennas use coaxial cables in the feeding network for distributing the signal to the radiators. With coaxial cables signals can cross each other without problem, but coaxial cables of practical dimensions introduce significant loss in the feeding network. A feeding network with air coaxial lines as described in WO 2005/101566 A1 is basically arranged in two dimensions, which means that signals cannot cross each other. This new invention therefore also, according to a preferred embodiment, provides a solution to this problem by having the signal pass through the reflector and travel along a micro-strip line splitter/combiner on the reflector front side and then pass back through the reflector to the reflector back side.

The microstrip lines on the reflector front side can interact with the radiators and the adjacent lines, and thus reduce the isolation between the two channels. Means for increasing the isolation are known today. Typical solutions are parasitic elements or other arrangements on the reflector front side, but these solutions introduce additional manufacturing costs, and may not give the required isolation. A novel solution to this problem is to introduce controlled coupling between channels at the reflector back side that cancels the coupling on the antenna front side. This introduced coupling must be optimized in phase and amplitude in order to achieve efficient cancellation.

For a two-column antenna, the azimuth antenna beam shape primarily depends on a complex interaction between the width and shape of the reflector, the radiation diagram of the radiators and the separation between the radiators. Reducing the antenna beam width increases the antenna gain. It is a well-known fact that it is possible to achieve a narrower azimuth beam width by designing the outer parts of the reflector as shown in FIG. 5. This invention also, according to a further preferred embodiment, includes novel means to reduce the azimuth side lobe level by introducing a conducting ridge between the two antenna columns.

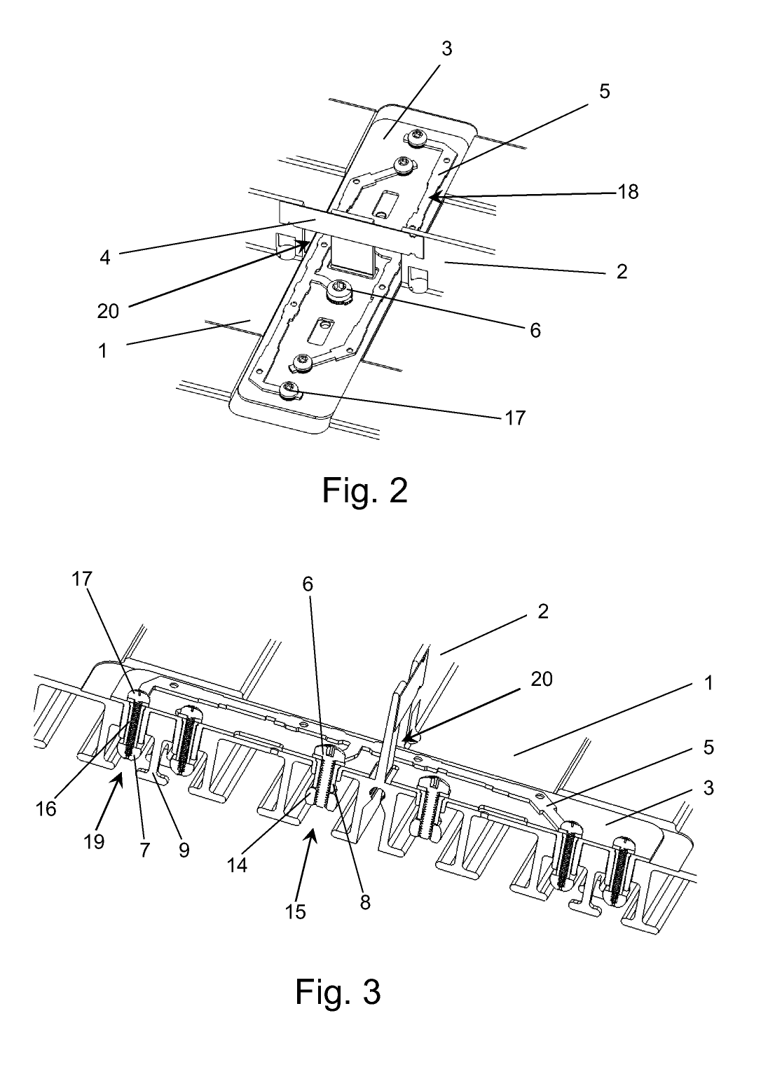

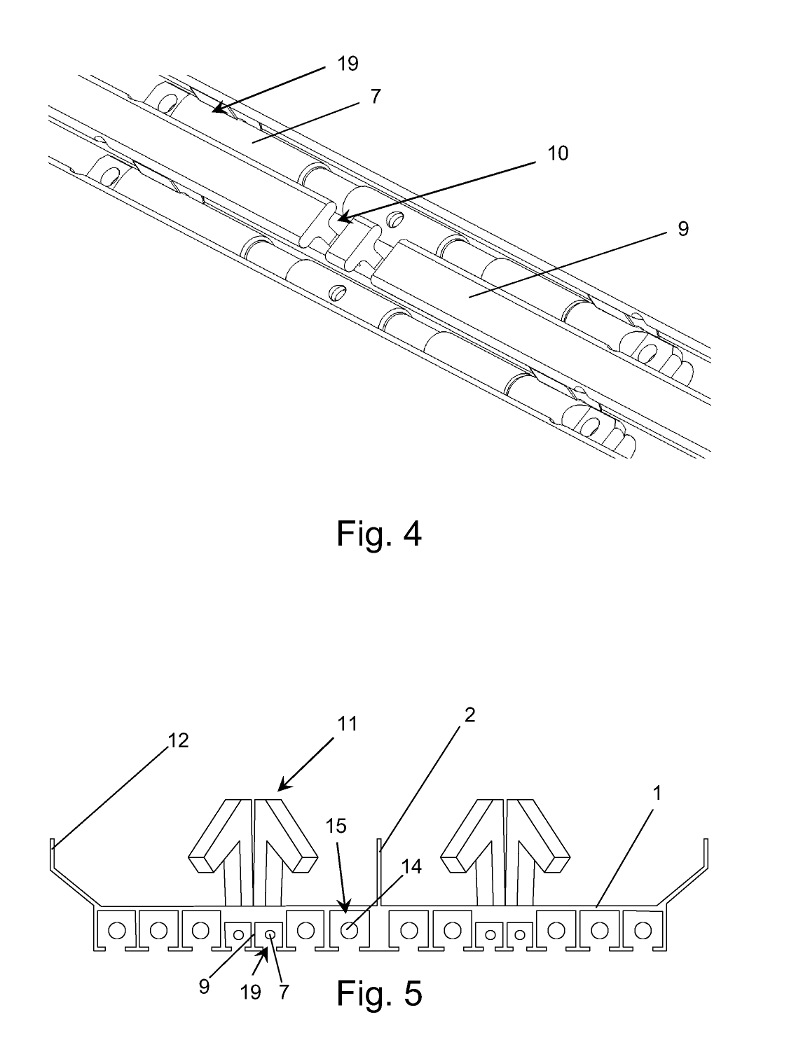

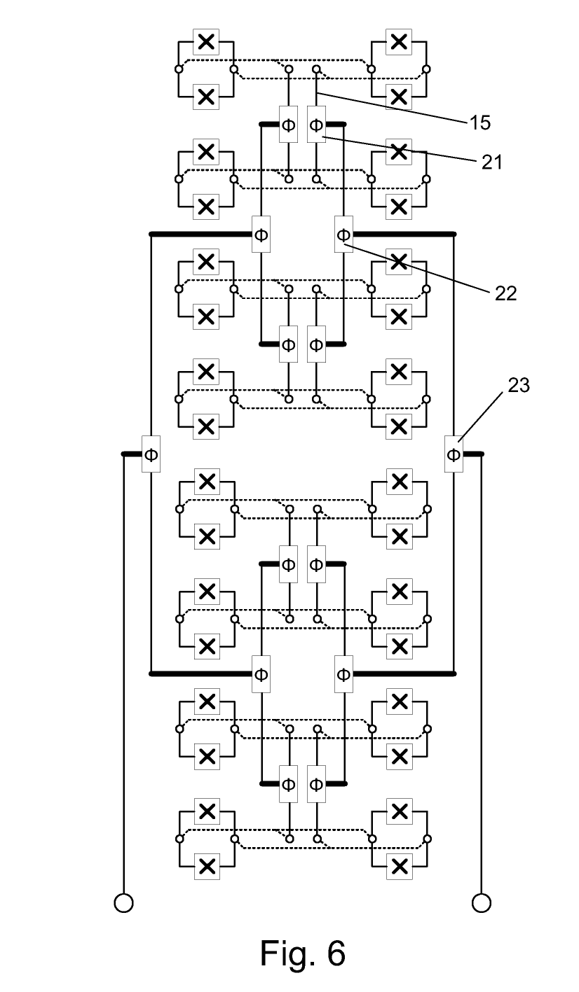

The invention will now be described in more detail in connection with a non-limiting embodiment of the invention shown on the appended drawings, in which FIG. 1 shows a feeding network for a novel two-column antenna with 32 radiators, FIG. 2 shows a part of the reflector front side with a microstrip line splitter/combiner, FIG. 3 shows a cross section of a part of the same splitter/combiner together with conductive spacers used to connect the microstrip line splitter/combiner with the air coaxial lines on the reflector back side, FIG. 4 shows two air coaxial lines with coupling apertures in the common outer conductor structure, FIG. 5 shows a cross-section of a reflector having a ridge between the two dipole columns, and FIG. 6 shows a feeding network including phase shifters for an antenna with a variable elevation tilt angle.

In FIGS. 2 and 3 is shown an embodiment of the microstrip line splitter/combiner arrangement 18 on the antenna reflector front side 1, but other embodiments with microstrip lines using other types of transmission lines could also be used.

The microstrip line splitter/combiner comprises a conductor 5, a dielectric isolator 3 and a ground plane. In this embodiment, the reflector 1 acts as a ground plane. The microstrip line splitters/combiners 18 also split the signal so that it can feed the radiators 11 in each antenna column. The signal enters on the air coaxial line 15. It then passes through the reflector 1 using a conductive spacer 8 that connect the coaxial line 15 inner conductor 14 to the microstrip line splitter/combiner conductor 5. The signal is then split in two, and each signal again passes the reflector via other conductive spacers 16 to the inner conductor 7 of the coaxial lines 19 that are connected to the radiators 11. The screws 6 and 17 mechanically hold the conductive spacers 8 and 16 in place between the coaxial lines inner conductors 7, 14 and the microstrip line splitter/combiner conductor 5. This is one way to connect the microstrip line splitter/combiner 18 on the reflector 1 front side to the coaxial lines 15, 19 on the reflector back side, but other ways are also possible.

Because the signals now also travel on the antenna reflector front side, signals will couple between the radiators 11 and the microstrip line splitters/combiners 18. If the dielectric isolator 3 is sufficiently thin, this coupling will be insignificant when it comes to antenna pattern and gain, but will have an effect on the isolation between the two channels. Isolation will also be reduced because of coupling between two adjacent microstrip line splitters/combiners 18.

In the air coaxial line feeding network that is used, signals from the two channels travel on the parallel coaxial lines 19 that run next to each other only separated by a common coaxial line outer conductor structure 9. By making small apertures 10 in this common outer conductor structure 9, it is possible to couple a signal from one coaxial line to the other, and thereby affect isolation between the two channels. The size of this aperture 10 will determine the amplitude of the coupled signal, and the position of the aperture will determine the phase of the signal. Thus, the cancellation mentioned above can be optimised. The main advantage is that this type of cancellation does not require any extra parts that would have added to the complexity and cost of the antenna. This arrangement can be combined with known methods for increasing polarisation isolation such as parasitic elements, the advantage being that increased isolation is achieved and the number of parasitic elements needed is reduced.

FIG. 5 shows the shape of the antenna reflector used in this embodiment. The reflector outer edges 12 are angled inwards in order to reduce the antenna beam width and to reduce the azimuth side lobe level. The open coaxial lines 15 and 19 included in the feeding network are integrated with the antenna reflector 1 in the same way as in applicant's earlier application WO 2005/101566 A1. The radiators 11 are placed on the reflector 1 front side. A conductive ridge 2 is also included in the reflector, between the two columns of radiators 11, and will reduce the azimuth side lobe level. The reflector can preferably be manufactured as an aluminium extrusion.

The microstrip line splitter/combiner 18 has to pass through the ridge 2 in order to interconnect the two antenna columns. It is therefore necessary to open up the ridge 2 where the is microstrip line splitter/combiner 18 must pass. It is important to keep those openings 20 for the microstrip lines sufficiently small to get the desired effect on azimuth side lobe level. For manufacturing reasons it is necessary to open up the full height of the ridge 2. These openings 20 significantly reduce the positive effects of the ridge. By electrically connecting the upper parts of the ridge 2, the azimuth side-lobe performance will be similar to that without openings in the ridge. The connection can be galvanically connected to the reflector ridge, or capacitively connected to the reflector ridge by means of a thin isolating layer. An embodiment of this solution is shown in FIG. 2, where a metal plate 4 with an isolating adhesive is attached to the ridge 2.

In another embodiment, FIG. 6, variable differential phase shifters 21, 22, 23 are included in the two-column antenna feeding network. FIG. 6 shows how differential phase shifters 21, 22, 23 can be located within the feeding network to allow for variable elevation tilt functionality. The further details of these variable differential phase shifters are described in another application of the applicant and with the same inventors filed simultaneously with the present application.

1. A multi radiator base station antenna, comprising: a feeding network having air filled coaxial lines (15; 19), wherein the coaxial lines form an integrated part of a back side of an antenna reflector (1), and wherein the coaxial line comprises an outer conductor (9) and an inner conductor (7; 14); and two parallel columns of radiators (11) that are placed on a front side of the antenna reflector (1), the radiators (11) being fed from said feeding network.

2. The antenna according to claim 1, wherein the radiators (11) are dual polarised.

3. The antenna according to claim 1 or 2, wherein the outer conductors (9) of the coaxial lines have a longitudinal slit.

4. The antenna according to claim 3, wherein a feeding network for the radiators (11) comprises a microstrip line (18) on the reflector (1) front side.

5. The antenna according to claim 4 wherein the microstrip line (18) acts as a splitter/combiner.

6. The antenna according to claim 4, wherein apertures (10) have been made in the coaxial line outer conductor structure (9).

7. The antenna according to any of claim 1 or 2, wherein the antenna reflector (1) has a longitudinal ridge (2) between the two radiator columns.

8. The antenna according to claim 7, wherein openings (20) are arranged in the radiator ridge (2) overbridged by a conductive plate (4) galvanically connected to the ridge (2).

9. The antenna according to claim 7, wherein openings (20) are arranged in the radiator ridge (2) overbridged by a conductive plate (4) capacitively connected to the ridge (2).

10. The antenna according to claim 1 or 2, wherein at least one adjustable phase shifter (21) using a dielectric part is arranged in the antenna and wherein the dielectric part is being movable longitudinally in relation to at least one coaxial line (15).
